(19) United States
(12) Patent Application Publication
(10) Pub. No.: US 2002/0048137 A1
(43) Pub. Date: Apr. 25, 2002

(54) Two-layered embedded capacitor

(76) Inventors: Thomas J. Williams, Concord, NH (US); William D. Varnell, Concord, NH (US); Robert J. Sanville, Laconia, NH (US)

Correspondence Address: David B Bernstein Esq, Mintz Levin Cohn Ferris Glovsky And Popeo PC, One Financial Center, Boston, MA, 02111, US

(21) Appl. No.: 09/538,823

(22) Filed: Mar. 30, 2000

Related U.S. Application Data
(63) Continuation-in-part of application No. 09/276,370, filed on Mar. 25, 1999.
(60) Provisional application No. 60/080,250, filed on Apr. 1, 1998.

(51) Int. Cl. H01G 4/35

(52) U.S. Cl. 361/302

(57) ABSTRACT

A novel capacitor foil and printed circuit board intermediate made using that foil are disclosed. The capacitor foil is a two-layer construction having a conductive layer and a partially cured bonding layer having a high dielectric constant. The high dielectric bonding layer is formed with epoxy or other polymer and is loaded with capacitive ceramic particles or pre-fired ceramic forming particles. The resulting capacitor foil may be applied to a laminate having copper patterns thereon to define a PCB intermediate containing at least one buried capacitor device. Multiple layers of capacitance material also can be used to increase the overall capacitance of the board.

### RELATED APPLICATIONS

This application is a continuation-in-part of pending U.S. application Ser. No. 09/276,370, filed Mar. 25, 1999 and which is entitled “Parallel Plate Buried Capacitor”.

### FIELD OF THE INVENTION

The present invention relates generally to printed circuit boards and printed wiring boards for use in the electronics industry. More specifically, the present invention relates to a printed circuit board having at least one embedded capacitor. In one application, such capacitors may be used as decoupling capacitors for integrated circuits installed on the printed circuit board. In another application, such capacitors may be isolated to provide discrete capacitance to installed components.

### BACKGROUND OF THE INVENTION

The electronics industry currently makes wide use of printed circuit and printed wiring boards (hereafter, collectively referred to as “printed circuit boards” or “PCBs”). Typical printed circuit boards can include multiple composite layers formed from organic and inorganic materials and include both internal and external wiring. The boards allow electrical components to be mechanically supported and electrically connected among one another. As electronic technology advances, the trend is toward placing increasing numbers of interconnect layers, greater pass-through hole densities (permitted by small hole diameters), and finer line (trace) widths on the boards. Each of these is intended to allow a greater number of devices to be installed on a printed circuit board having a given size.

Despite the development of printed circuit boards that allow greater device densities, little progress has been made regarding the ability to build active or passive electronic devices as integrated elements during manufacture of a multi-layer printed circuit board. This is a result of numerous problems that are associated with device and board integration. For example, printed circuit board manufacturing processes and circuit manufacturing processes are substantially incompatible with regard to the required degree of cleanliness, thermal cycling, photolithography and other requirements.

In applications in which a printed circuit board is intended to carry a large number of integrated circuit devices, a correspondingly large number of decoupling capacitors is required. The decoupling capacitors provide instantaneous current requirements for the integrated circuits and also serve to reduce system noise. Unfortunately, the numerous decoupling capacitors can occupy considerable printed circuit board surface area, and at the same time require extra assembly of the overall device in that they must be positioned on and affixed to the printed circuit board. As a result, the requirement for decoupling capacitors adds significantly to the overall cost of manufacture of electronic devices.

Recently, methods for burying a capacitor within the circuit board have been developed. Of these methods, two are currently acceptable from a practical commercial standpoint. The first method uses a thin, substantially copper clad, epoxy-impregnated fiberglass laminate as a parallel plate capacitor. Although the overall dielectric constant of the composite material (i.e. the fiberglass laminate), is relatively low, (approximately 4.5), the capacitance is still high enough to be effective in some cases. This is particularly true when the laminate used is relatively thin, (i.e., on the order of approximately 0.002 inches). The second method for burying a capacitor within a circuit board involves the application of a filled epoxy containing a high percentage of ceramic filler or pre-fired ceramic forming materials to a roll of copper foil. (As used herein, the term “ceramic filler” is intended to encompass pre-fired ceramic forming materials as well as ceramic fillers). The roll can then be cut into sheets, positioned in a face-to-face relationship with the filled epoxy surfaces contacting each other, and then exposed to elevated temperatures and pressures to form a laminate. The overall capacitance of this type of buried capacitor is approximately four times that of the epoxy-fiberglass parallel plate type described above. This is a result of the presence of the ceramic, which imparts a high dielectric constant to the laminate body. Unfortunately, however, this method produces a laminate that is approximately 4-5 mils thick because each of the sheets used is approximately 2.5 mils thick and two such sheets must be pressed together in order to achieve the proper bond strength. Likewise, the overall strength requirements of the laminate lead to such thicknesses in order to produce a structure that is sufficiently strong to be processed using standard printed circuit board fabrication methods.

Thus, it should be apparent that a need exists for a simple, low cost method of providing a low-profile integrated (i.e., buried) capacitor in a printed circuit board, and for integrated capacitors which have a capacitance that exceeds the capabilities of buried capacitors currently known in the art.

### SUMMARY OF THE INVENTION

The present invention relates generally to printed circuit boards having one or more integrated or buried capacitors. More particularly, the present invention relates to a capacitor foil for use in forming buried parallel plate capacitors on a printed circuit board intermediate. The capacitor foil includes a conductor layer, and a relatively high dielectric constant bonding layer. The conductor layer may be used to define the power plane of a capacitor while the dielectric bonding layer may be used to define the dielectric layers of a capacitor. The dielectric bonding layer is formed of a partially cured epoxy or other polymer resin system typically used in the printed circuit board industry, (i.e., polyimides, Bismaleimide triazines, cyanate esters, etc.), and which is filled with ceramic particles or pre-fired ceramic forming particles. It is noted that the term “dielectric layer” as used throughout the specification herein is intended to describe a layer of material having a relatively high dielectric constant.

In use, the capacitor film may be applied to the surface of a laminate which contains numerous copper patterns, each defining, for example, a ground plane of a discrete capacitor, and becoming an inner layer once the capacitor film is in place. By laminating the capacitor foil over the patterned inner layer, a PCB intermediate having a multiplicity of buried capacitors can be formed. Alternatively, if the patterned inner layer is such that there is one solid, contiguous sheet of copper, one large capacitor is formed. If such a single, large capacitor is formed, the capacitance can be shared among all parts of the board. The intermediate may subsequently be processed using any of a wide variety of PCB processing steps in order to fabricate an electronic device based upon a PCB having internal capacitance.

### BRIEF DESCRIPTION OF THE DRAWINGS

FIG. 1 is an elevational view of one embodiment of a capacitor foil of the present invention.

FIG. 2 is an elevational view of one embodiment of a PCB intermediate of the present invention.

### DETAILED DESCRIPTION

The present invention relates to a novel material for use in forming buried parallel plate capacitors as well as to a process for forming such capacitors. In addition, the present invention relates to a printed circuit board intermediate which incorporates at least one buried parallel plate capacitor.

The parallel plate capacitors of the present invention are made using a copper foil on which a filled epoxy resin has been coated. The resin is filled with high dielectric particles, typically ceramic, described in detail below, which provide it with enhanced dielectric properties. The resulting structure, hereafter termed a “capacitor foil”, is a two layer body having a copper layer and a filled, high dielectric constant, particle loaded, resinous bonding layer.

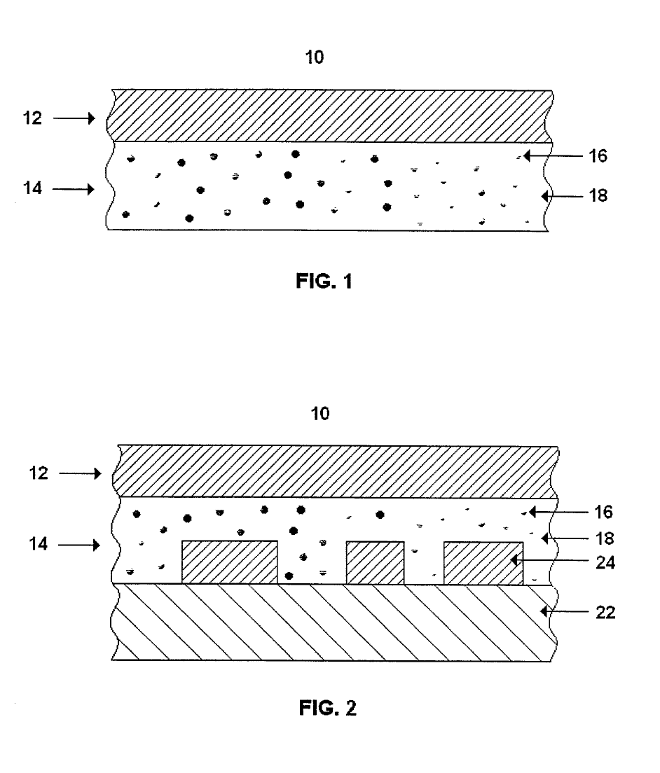

One embodiment of the capacitor foil may be seen in FIG. 1. Specifically, FIG. 1 shows a capacitor foil 10 which includes a conductive layer 12 of a copper foil, and a bonding layer 14 of a ceramic-filled, relatively uncured resin. In one embodiment, the ceramic-filled resin which forms a high-dielectric bonding layer 14 includes numerous ceramic particles 16 encapsulated within a surrounding epoxy matrix 18. The dielectric bonding layer 14 may have a thickness in the range of about 0.0005 inches to about 0.003 inches, but more preferably, it has a thickness in the range of about 0.001 inches to about 0.002 inches before pressing. The copper forming the conductive layer 12 typically has a thickness on the order of about 9 micrometers to about 360 micrometers.

The dielectric bonding layer 14 is composed of high dielectric filler materials and an epoxy resin system. The filler material can be a ceramic powder, such as Y5V ceramic capacitor formulation, commercially available from Tam Ceramics, Niagara Falls, N.Y. or from TPL Inc., Albuquerque, New Mexico. In a typical application, the filler 16 comprises approximately 30-80% of the ceramic-filled epoxy by volume and approximately 60-97% of the ceramic-filled epoxy by weight. In one preferred embodiment, the filler 16 comprises approximately 50% of the ceramic-filled epoxy by volume and approximately 90% of the ceramic-filled epoxy by weight. As pointed out above, however, the invention is not intended to be limited to epoxy resin systems. Rather, any of a wide variety of polymer resins known in the art may be used to form the high-dielectric constant bonding layer 14.

The partially cured resin which forms the high-dielectric constant bonding layer 14 may also be any of a wide variety of epoxies known in the art. In one preferred embodiment, a highly brominated epoxy such as high brominated epoxy commercially available from Dow Chemical, Midland, Mich. under the trade name 71920.03 may be used, as well as DER 592 or DER 542, also available from Dow, or Epon 1163, for example, commercially available from Shell Chemical. Another embodiment uses a non-brominated epoxy resin such as Epon 828 produced by Shell Chemical as the preferred resin system. Again, however, the invention is not intended to be limited to epoxy resin systems. Rather, any of a wide variety of polymer resins may be used to form the bonding layer 14.

Parallel plate capacitance, in general, can be determined by the equation:

C=κAε/d

where C represents the capacitance of the capacitor, κ represents the dielectric constant of the substance, A represents the area of the capacitor, ε represents the permittivity of free space, and d represents the distance between the two plates. Thus, by increasing the dielectric constant of the dielectric layer 14 through the use of ceramic filler 16, or by using polymer resin systems having an inherently high dielectric constant, and by decreasing the distance between the plates through the use of a thin construction, the capacitance of the resulting device can be substantially increased.

In the device shown in FIG. 1, after the high-dielectric constant bonding layer 14 is coated onto the copper conductive layer 12, it is partially cured. The partial curing provides a means of regulating the total thickness and uniformity of thickness of the dielectric layer, and allows a strong chemical bond to be formed between it and the substrate to which it is to be bonded. Curing is typically carried out under the following conditions: 300-400° F. (149-204° C.) in a multiple zone oven. The first zone usually has a lower temperature and is used to drive off solvent. Subsequent zones are used to cure the polymer. Oven dwell time is typically about 2-5 minutes depending on the length of the zones, the reactivity of the particular resin formula being cured and the degree of cure desired. The resulting structure is particularly useful in the fabrication of a buried parallel plate capacitor in the manner described below.

In use, a segment or section of a standard PCB inner layer having a copper coating or layer on one surface thereof is provided. The inner layer dielectric material is any of a wide variety of such materials known in the art of PCB fabrication. The copper conductive layer can ultimately act as the power or ground plane in the PCB. The copper layer on the surface of the board is patterned, using any of a variety of well-known processing techniques in order to define desired capacitive areas on the surface of the board, and clearances for routing. Subsequently, a sheet of capacitor foil 10 of the type shown in FIG. 1 is adhered and laminated to the patterned board. Any of a wide variety of well-known lamination procedures may be used to achieve this lamination step, such as curing in a press at about 150-350 psi for about 30-120 minutes for epoxy. Other polymer systems will require press cycles tailored to their own individual needs. It is noted that during this lamination, a portion of the filled, partially cured resin that forms the high dielectric, bonding layer is squeezed out to the edges of the capacitor foil and removed and/or fills open areas within the inner layer. As such, the application of the capacitor foil to the surface of the PCB increases the board thickness by a degree on the order of the thickness of the conductive layer and a fraction of the dielectric layer thickness.

A printed circuit board product in the form of an intermediate for use in further processing is shown in FIG. 2. As can be seen in FIG. 2, the capacitor foil 10 of the present invention has been applied to the surface of a laminate 22 upon which are patterns 24 of copper. More particularly, the intermediate PCB includes the capacitor foil 10 having a conductive layer 12, and a high-dielectric constant bonding layer 14 applied to the surface of a patterned PCB. Capacitors are created in the regions of the copper patterns 24 that have been formed on the laminate 22. Thus, each patterned region 24 can serve as a capacitor ground plane, while the high-dielectric bonding layer 14 and the conductive layer 12 above it define the remaining parts of the capacitor. Thus, when a copper pattern 24 is used as a ground plane, the conductive layer 12 separated from the ground plane by the high-dielectric bonding layer 14 constitutes a power plane for the capacitor.

It should be noted that although the device depicted in FIG. 2 may include a large multiplicity of various capacitors, its appearance is very similar to that of a laminate having a copper layer deposited on its surface. This intermediate PCB may be further processed to pattern the conductive layer 12, to provide additional layers, or to take advantage of any of the other processing steps commonly associated with PCB manufacture. Thus, the resulting product will be substantially the same as known PCBs, with the exception that the completed unit will include at least one capacitor buried within its multi-layered construction.

The resulting capacitor-containing PCB intermediate has typical thicknesses ranging from about 0.008-0.05 inches (0.020-0.127 cm). Such structures are unique in that they allow the fabrication of completed PCBs containing numerous effective capacitors, without the disadvantage of undue thickness. As such, the capacitor foil and PCB intermediates of the present invention provide the device fabricator with the ability to use a PCB of a substantially smaller size since there is no need to apply numerous external capacitors thereto.

Equivalents

From the foregoing detailed description of the specific embodiments of the invention, it should be apparent that a unique capacitor foil and capacitor-containing PCB, as well as methods of manufacture of such devices, has been described. Although particular embodiments have been disclosed herein in detail, this has been done by way of example for purposes of illustration only, and is not intended to be limiting with respect to the scope of protection to which the applicants may be entitled. In particular, it is contemplated by the inventors that various substitutions, alterations, and modifications may be made to the invention without departing from the spirit and scope of the invention.

What is claimed is:

1. A capacitor foil which comprises a two layer body having:
a) a conductive surface;
b) a filled resin, the resin being loaded with a filler comprising particles having a high dielectric constant, and wherein the filled resin comprises a high dielectric constant layer which is also used as a bonding surface.

2. A capacitor foil as in claim 1, wherein the conductive surface comprises a copper foil.

3. A capacitor foil as in claim 1, wherein the dielectric layer comprises a filled epoxy resin.

4. A capacitor foil as in claim 3, wherein the epoxy resin is filled with ceramic particles.

5. A capacitor foil as in claim 4, wherein the epoxy resin comprises a bisphenol A epoxy resin.

6. A capacitor foil as in claim 4, wherein the ceramic particles comprise between about 30% and about 80% by volume of the filled epoxy resin.

7. A capacitor foil as in claim 6, wherein the ceramic particles comprise between about 60% and about 97% by weight of the filled epoxy resin.

8. A printed circuit board intermediate which comprises:
a) a substrate laminate;
b) a conductive pattern formed upon one surface of the substrate laminate; and
c) a capacitor foil applied upon at least a portion of the conductive pattern, the capacitor foil comprising:
i) a conductive surface;
ii) a filled resin, the resin being loaded with a filler comprising particles having a high dielectric constant, and wherein the filled resin comprises a dielectric layer which is also used as a bonding surface.

9. A printed circuit board intermediate as in claim 8, wherein the conductive surface comprises a copper foil.

10. A printed circuit board intermediate as in claim 8, wherein the dielectric layer comprises a filled epoxy resin.

11. A printed circuit board intermediate as in claim 10, wherein the epoxy resin comprises a bisphenol A epoxy resin.

12. A printed circuit board intermediate as in claim 10, wherein the epoxy resin is filled with ceramic particles.

13. A printed circuit board intermediate as in claim 12, wherein the ceramic particles comprise between about 30% and about 70% by volume of the filled epoxy resin.

14. A printed circuit board intermediate as in claim 12, wherein the ceramic particles comprise between about 60% and about 97% by weight of the filled epoxy resin.
